(19) United States
(12) Patent Application Publication
(10) Pub. No.: US 2015/0310136 A1
(43) Pub. Date: Oct. 29, 2015

(54) ARCHITECTURAL DESIGN DASHBOARD

(71) Applicant: Andrew S. Maletz, New Albany, OH (US)

(72) Inventor: Andrew S. Maletz, New Albany, OH (US)

(73) Assignee: WD Partners, Inc., Dublin, OH (US)

(21) Appl. No.: 14/694,236

(22) Filed: Apr. 23, 2015

Related U.S. Application Data
(60) Provisional application No. 61/983,818, filed on Apr. 24, 2014.

(51) Int. Cl. G06F 17/50

(52) U.S. Cl. CPC G06F 17/5004

(57) ABSTRACT

Systems and methods of automated architectural design are disclosed. A user can access a user account associated with information such as model prototypes, families, component models useable to assemble a complete building model based configuration selections, etc., and can be associated with one or more entities (e.g., a company that uses similar building designs at various stores, etc.). Building configuration options can be presented to a user, and various configuration options selected by the user can be received. Appropriate component models having attributes (e.g., including appropriate building materials, etc. corresponding to the building code, appropriate building design for wind considerations, etc.) corresponding to the received configuration inputs can be selected. A building model can be constructed as a kit-of-parts from the component models selected based on the received user inputs.

### CROSS-REFERENCE TO RELATED APPLICATIONS

This application claims the benefit of U.S. Provisional Patent application Ser. No. 61/983,818 entitled “ARCHITECTURAL DESIGN DASHBOARD” and filed Apr. 24, 2014. The entirety of the above-noted application is incorporated by reference herein.

### BACKGROUND

Building information modeling (BIM) relates to the generation and management of databases representing physical and functional characteristics of sites and/or buildings. A BIM platform can provide for three dimensional designing of a building and the building's associated components, as well as the objects used to populate the building model, e.g. furniture, fixtures, building materials, etc. The building model can be a database output of the BIM platform. However, it can be time consuming to become proficient with such a platform. Further, design can be time consuming as the platform offers too many details to select manually. For example, a BIM platform user must manually manipulate the design model when switching between architectural styles and/or design themes. Additionally, if multiple similar buildings are going to be designed by the same company, e.g. different locations for stores owned or franchised stores, etc., re-design of each building to meet regional or site-specific requirements of the buildings can add additional time and expense to the project(s) using conventional systems, due to the duplication of information.

### BRIEF DESCRIPTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems and methods of automated architectural design. A user, e.g., architect of record (AOR), can access a user account populated with information such as model prototypes, families, component models useable to assemble a complete building model and corresponding construction documents based on configuration selections, etc., and can be associated with one or more entities, e.g., a company that uses similar building designs at various stores, etc. Building configuration options can be presented to a user, and various configuration options selected by the user can be displayed. Appropriate or suggested component models corresponding to the received configuration inputs can be selected. The component models can include appropriate or suggested building materials, etc. corresponding to the building code, and/or appropriate building design for climate or geographical locations, e.g., wind and climactic considerations, etc. A building model can be constructed as a “kit-of-parts” from the component models selected based on the received user inputs.

How the model is built influences how a dashboard of the subject innovation can interface and control it. In various embodiments, the subject innovation provides systems and methods of model manipulation to interface with the dashboard. In aspects, the subject innovation can produce multiple variations of a model through automation and the use of the dashboard.

Aspects of the innovation can provide the ability for a user e.g., an Architect of Record (AOR) to “order” a model for a site specific application. In an example embodiment, an AOR can log into or otherwise access the dashboard and navigate through a predetermined set of criteria for a building for a specific geographical location. These criteria can be based on a variety of factors, such as how the model was built, what options are available in the model, etc. The dashboard can interact with the model and BIM platform to simultaneously provide customization and automation in a readily accessible interface. Once a site specific model configuration is chosen, the dashboard and custom application programming interfaces (APIs) can be used to take the base prototype model and make the AOR model. That AOR model can then be bound and stripped of the model manipulation and APIs.

In aspects, the subject innovation can also provide substantial benefits in terms of redesign of architectural models. For example, if a company is rebranding, they may need to redesign multiple aspects of each of a plurality of stores or locations. Conventionally, this rebranding involved redesign of each of potentially hundreds of models, and considerable expense. However, in aspects of the subject innovation, individual components across multiple locations can be changed in a unified experience, and the potentially hundreds of stores can then be recreated as described herein.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates a representation of an example model of a wall, door, and window in a modeling program.

FIG. 2 illustrates a perspective view of an example building model and example factors and decisions that can go into design of a model via a kit of parts approach.

FIG. 3 illustrates an example component diagram of a system for facilitating architectural design.

FIG. 4 illustrates a screenshot of an example interface of a dashboard and a user login to the example dashboard.

FIG. 5 illustrates a screenshot of example configuration options related to store number, developer, and location.

FIG. 6 illustrates a screenshot of example configuration options related to building codes, region-specific requirements, and wind designs.

FIG. 7 illustrates a screenshot of example configuration options related to building codes, region-specific requirements, and wind designs.

FIG. 8 illustrates a screenshot of example configuration options related to specific site and building requirements.

FIG. 9 illustrates a screenshot of example configuration options related to additional design customization options.

FIG. 10 illustrates a screenshot of a dashboard interface providing for review of selected options prior to publishing the model.

FIG. 11 illustrates a screenshot of a report associated with categories and types of materials used by a company in connection with models designed via the subject innovation.

FIG. 12 illustrates a method that can be used in aspects of the subject innovation for generation of a model for a building in accordance with aspects of the subject innovation.

FIG. 13 illustrates a computer-readable medium or computer-readable device comprising processor-executable instructions configured to embody one or more of the provisions set forth herein, according to some embodiments.

FIG. 14 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

While certain ways of displaying information to users are shown and described with respect to certain figures as screenshots, those skilled in the relevant art will recognize that various other alternatives can be employed. The terms “screen,” “web page,” “screenshot,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

In aspects, the subject innovation relates to systems and methods that facilitate architectural design. In accordance with aspects of the innovation, a dashboard can be provided that includes a graphic user interface to a prototype model and/or an architectural model having a number of attributes. In aspects, the dashboard is reliant upon intelligence built into the model and categories of objects in the building information modeling (BIM) platform for controlling and reporting capabilities.

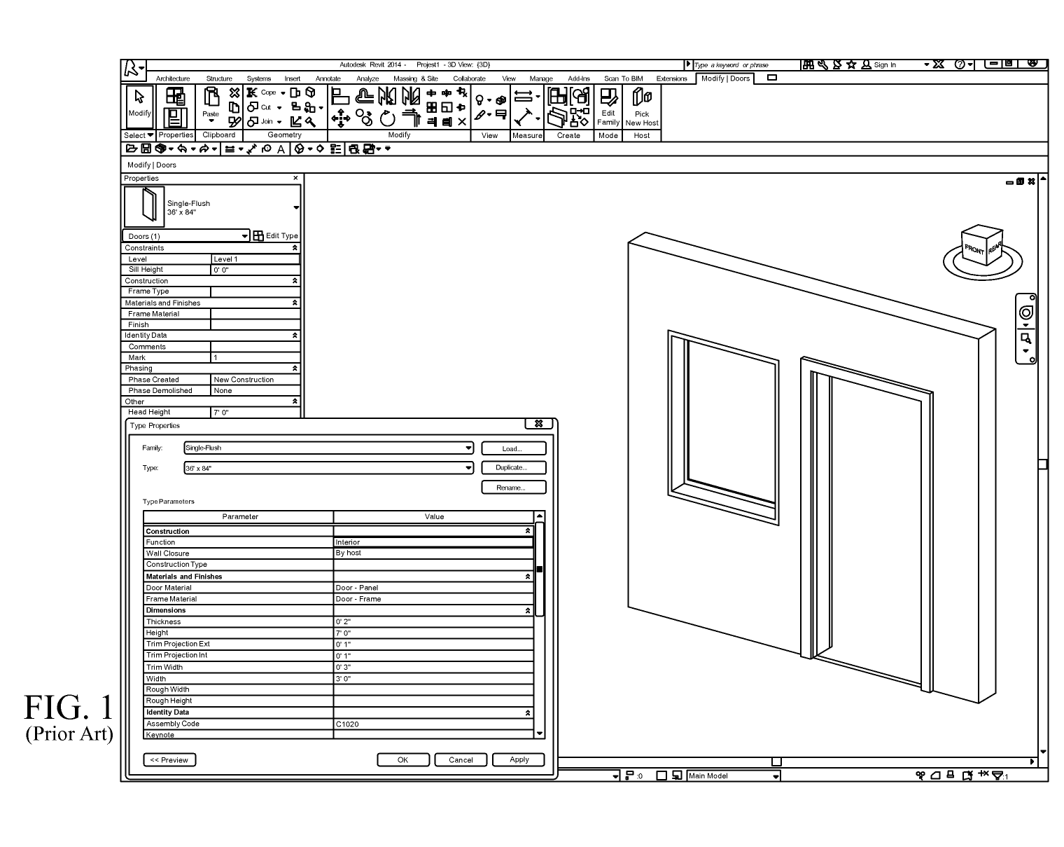

With reference to FIG. 1, a prior art representation of a model of a wall, door, and window is depicted in a conventional BIM platform. The BIM platform can be hardware, software, or combination of hardware and software. The BIM platform provides functionality for building design and/or site design. However, as stated above, such software requires significant training to use and is significantly limited with respect to functionality. For example, the BIM platform does not provide for automated design development pertaining to geographic-specific or site-specific customization of pre-existing models or prototype models, etc.

As will be described in detail infra, in aspects, a dashboard of the subject innovation can provide a user interface and associated functionality that interfaces with BIM software that allows for design of a building or structure and associated components, representing the physical and functional characteristics of the building. In various embodiments, a dashboard employable in connection with systems and methods of the subject innovation can provide a user with the functionality of the BIM software in an easily accessible manner. The dashboard can provide the functionalities of the model. In general, in aspects, there are at least two basic ways to build a model, either a kit of parts approach or an all-in-one approach. However, it is contemplated that there can be many different variations of the two basic principles.

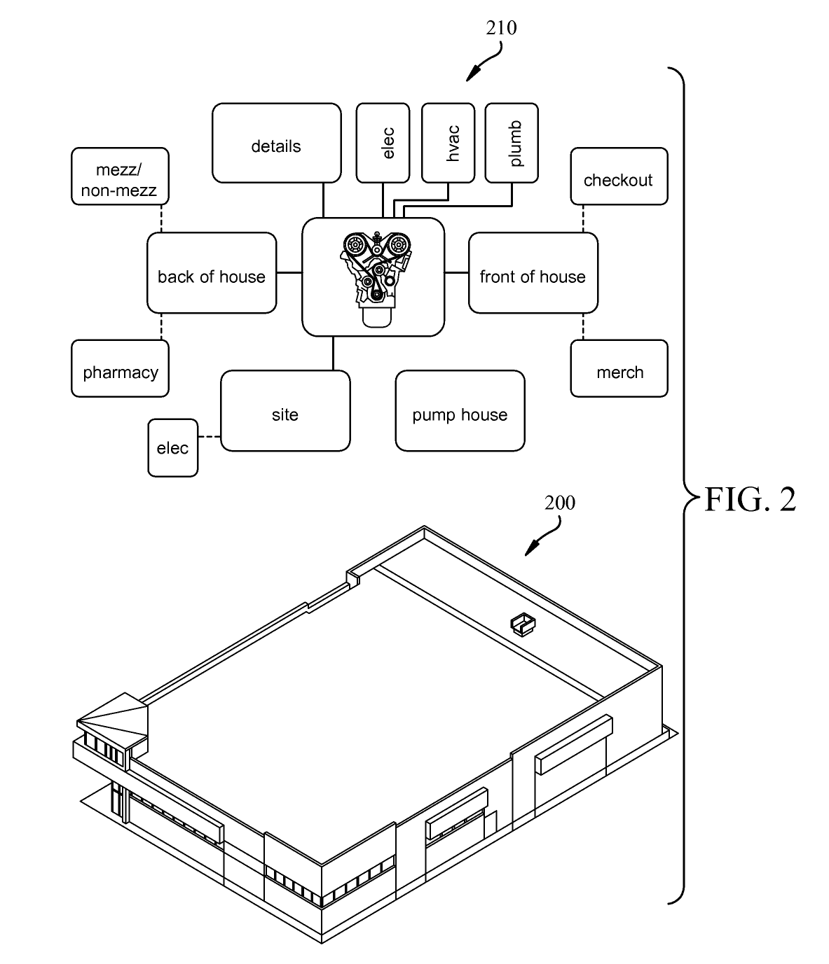

With reference to FIG. 2, a perspective view of an example model 200 is depicted along with exemplary factors and decisions that can be included in designing a model using a kit of parts approach 210. The kit of parts approach 210 includes multiple individual models that come together to form a model 200. Alternatively, models are designed using an all-in-one approach. The all-in-one approach reduces the time and expense of designing individual buildings. However, in aspects of the subject innovation, a kit of parts approach can be employed, wherein individual models corresponding to individual portions of a building can be created.

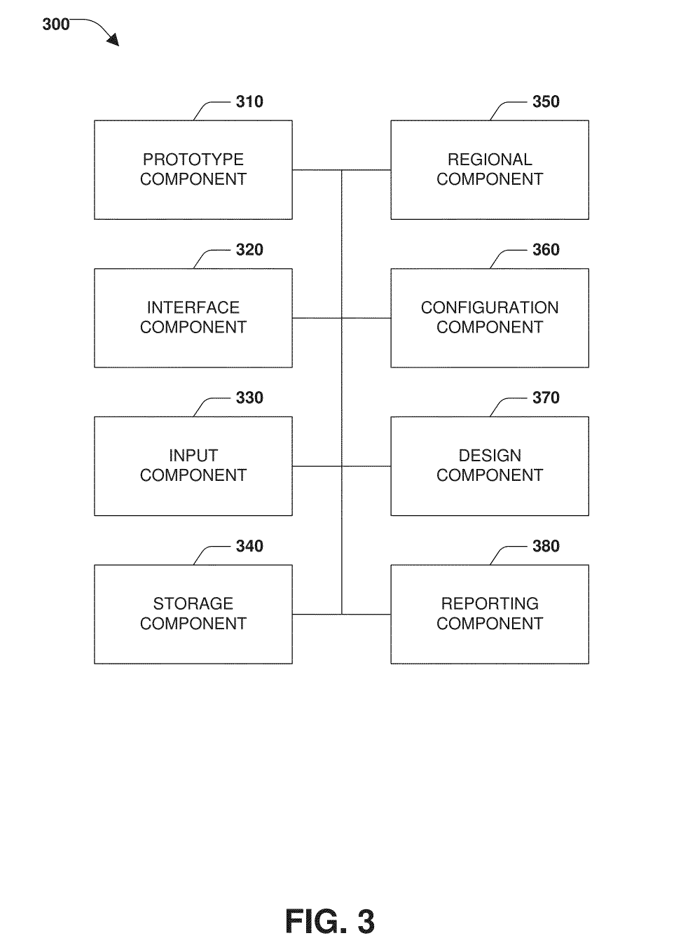

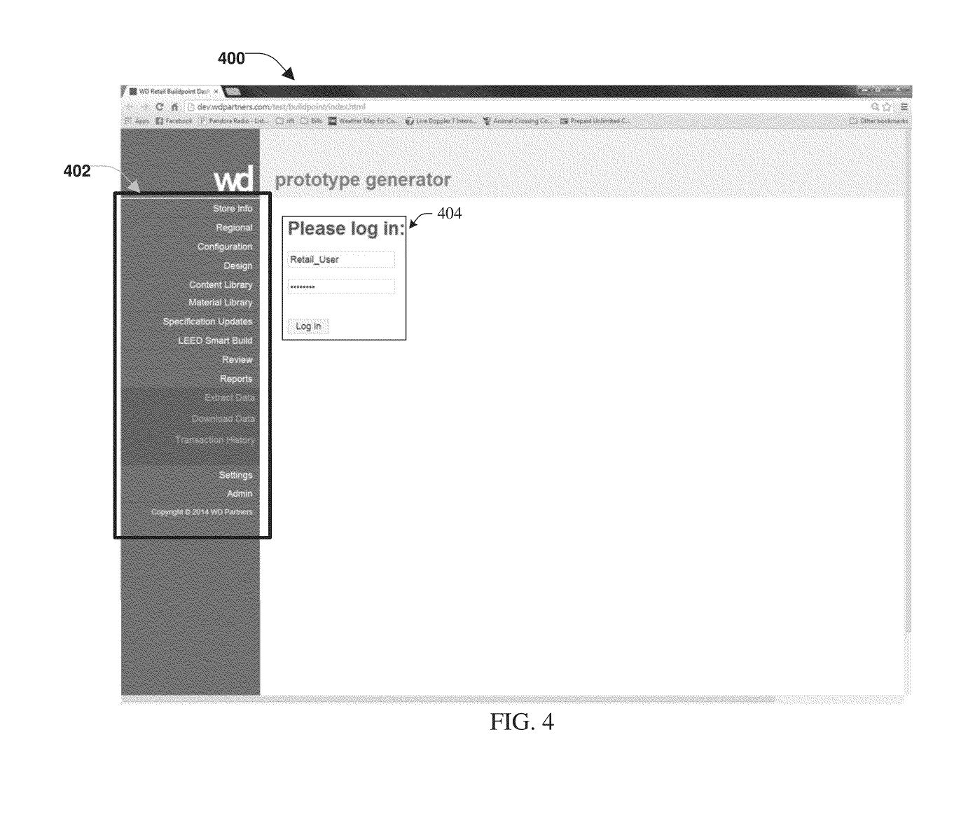

As illustrated in FIG. 3, an example modeling system 300 that facilitates designing models for building and/or building sites is shown. It is appreciated that the figures herein depict an exemplary design of an exemplary building, however other design objects are contemplated such as building sites, landscaping, and the like. FIG. 4 illustrates an example dashboard 400 is illustrated having navigation links 402 to different aspects of the dashboard which can assist in the understanding of the component functionalities of FIG. 3. In a specific example, the navigation links 402 of the dashboard 400 stay consistent through the design of the model. It is appreciated that components as illustrated are merely part of an exemplary component diagram. Additional components and/or less components are contemplated.

In one embodiment, the dashboard is customizable for different clients of the user and/or AOR. For example, a user can be presented with different attributes or options for different clients according to each clients' unique requirements and/or preferences.

Referring again to FIG. 3, the modeling system 300 includes a prototype component 310 for accessing, modifying, and/or detailing a prototype model of a building and/or site to a user. As a start point, a user accesses the prototype component 310 of the modeling system 300 by providing a user login and password 402 through an interface component 320 and an input component 330. In one or more embodiment, the input component 330 may enable accepting of one or more inputs from one or more users. In response to one or more of the inputs, the interface component 320 may cycle through one or more display modes having different parameters or different display information. The input component 330 may be implemented as software or hardware, as buttons, keys, a keyboard, include a microphone, or be received from the mobile device when a mobile device is docked with the interface component 320. The interface component may include a display such as LCD, TFT, LED, or the like for displaying views and/or models and navigation links 402 to the user within the dashboard 400.

The prototype component 310 accesses a storage component 340. The storage component 340 stores prototype models and/or template models for access by the modeling system 300 for reference and/or manipulation. The storage component 340 can be one of a database, hard disk drive, networked storage solution, or the like. In one or more embodiments, the modeling system 300 may utilize a communication channel or telematics channel to transmit (e.g., via the interface component 320) one or more requests and/or signals to a server or external storage device (not shown).

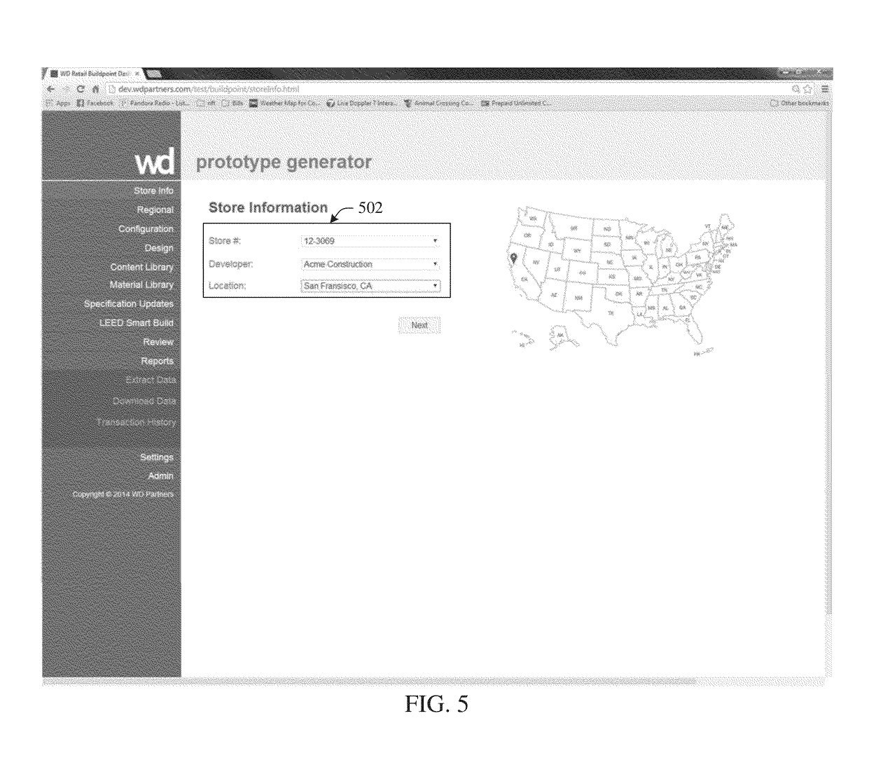

The modeling system 300 can modify the prototype model into an AOR model that is customized for the attributes and/or features required of the building to be developed. More particularly, the prototype component 310 can access and/or load a prototype model (e.g., user- or pre-defined) of a building or structure from the storage component 340. With reference to FIG. 5, in one embodiment, the prototype model is accessed according to user provided information 502. For example, the model can be a standardized building model for a franchise and/or franchisee. The user provides information such as store number, building developer, and/or location and the like. A store can be selected in order to build an associated building model from component models based on configuration selections. It will be understood and appreciated that the models described herein can be customizable to most any criteria including, but not limited to, location, franchise, owner, developer, climate, geography, region, etc. as well as combinations thereof.

The prototype model is retrieved from the storage component 340 with the initialized components and/or details as illustrated in FIG. 3. The prototype model can include an initialized starting set of attributes that the user can manipulate using the modeling system 300 to customize for specific criteria such as store information, region, building configuration, building materials, and the like.

In one embodiment, the prototype model can comprise an intelligent, parametric, three-dimensional visual representation of a database. Every element within the prototype model, as well as the model itself, can be a table or cell of information kept in a database. The tables of information can represent the items, walls, cabinets, chairs, etc. and the cells of information can represent these items respective colors, makes, models, etc. In one embodiment, the storage component 340 is a database that tracks and manages each element of the prototype model. While specific database storage structures are described herein, it is contemplated that most any database structure and architecture can be employed in connection with the innovation without departing from the spirit and/or scope of the disclosure and claims appended hereto.

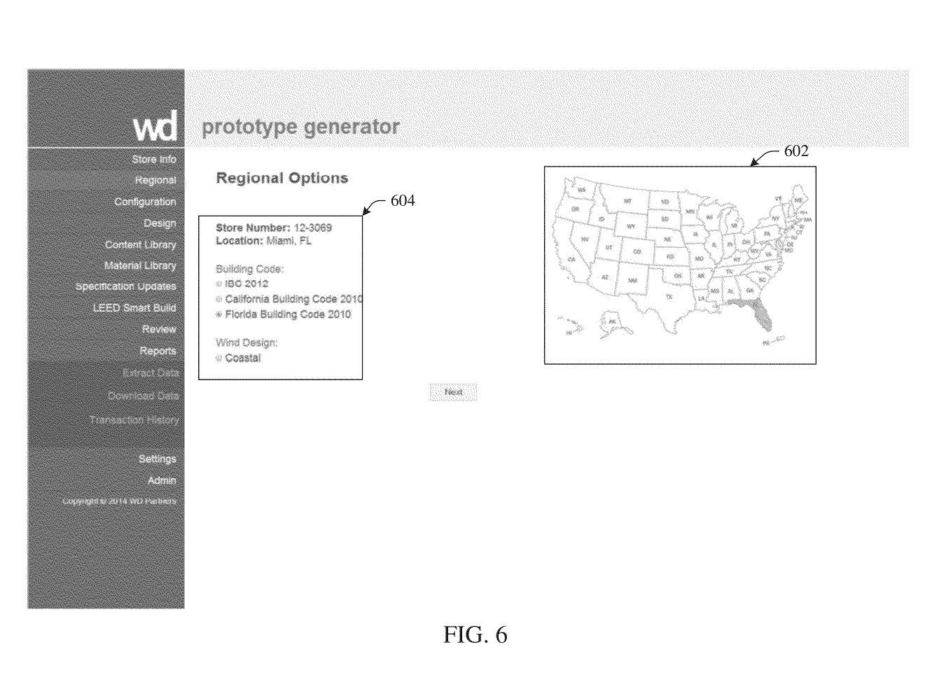

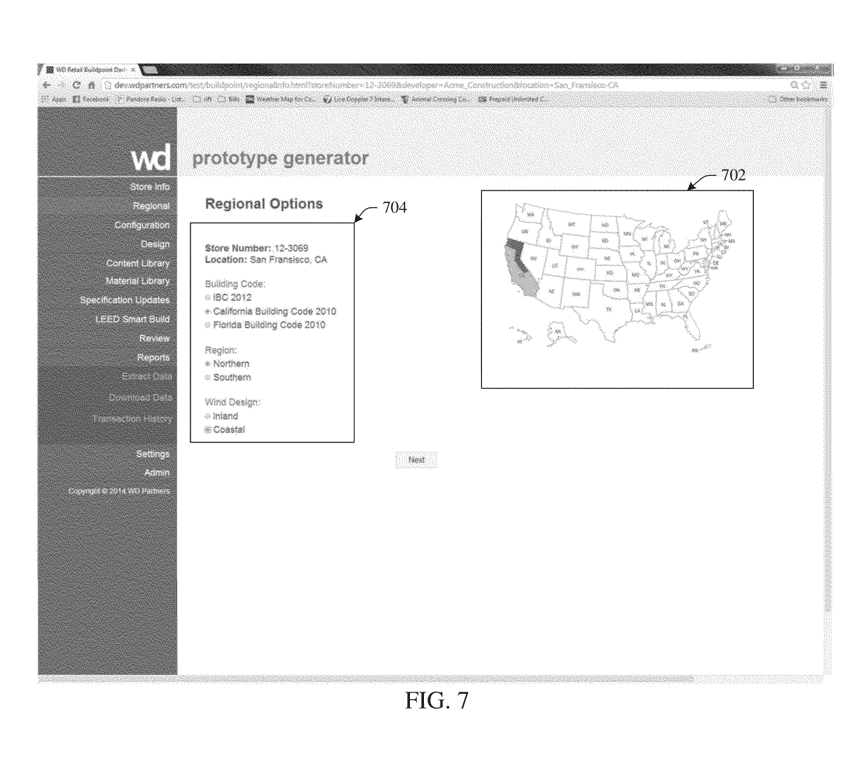

The modeling system 300 includes a regional component 350. The regional component 350 presents location specific requirements, attributes, and/or options. With reference to FIGS. 6 and 7, the regional component 350 displays a map visually depicting the building location. In one embodiment, the map can depict a jurisdiction for which specific building codes apply. For example, the map can depict statewide jurisdictions 602. As another example, the map can depict jurisdictions 702 within a state corresponding to type of building design required, or location within the state. The regional component 350 can access geographic attributes and considerations from the storage component 340. The regional component 350 displays further information 604, 704 to the user as shown. The further information can include the building codes applicable to the location. The further information can also include geographical requirements of the building such as wind design 604. In one embodiment, the user can manipulate the regional component 350 via the interface component 320 to select a wind design 704. For example, the prototype model can include a wind design for coastal winds and the user can select inland winds as option via the interface component 320.

Upon selection of an option, the modeling system 300 modifies the prototype model according to the new selection such that the model meets the requirements of the desired design, in this example, wind design. The prototype model is altered on a granular or elemental level according to the general selection of the wind design attribute. For example, a coastal wind design is selected by the user, then the prototype model is automatically altered by the regional component 350 to implement elemental modifications meeting the coastal wind design of a building such as stronger windows or sturdier building materials. In one embodiment, the wind design is automatically selected according to the location of the store. It is to be understood that use of the regional component 350 is specific to the described embodiment and that other customizable embodiments can be employed within the scope of the specification described herein.

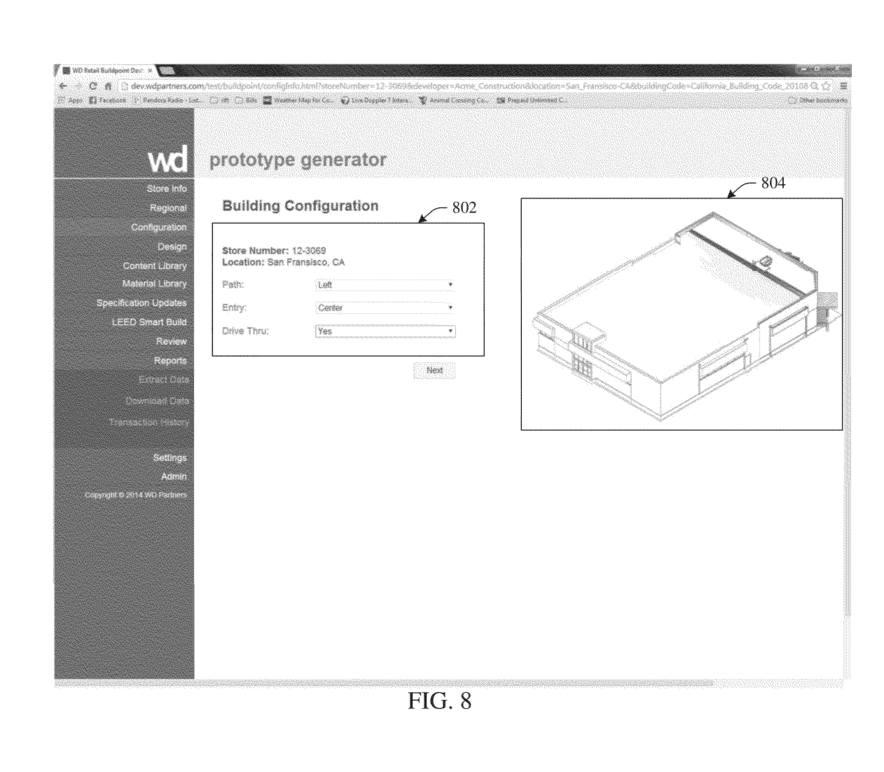

The modeling system 300 includes a configuration component 360 to enable additional customization of the prototype model. With reference to FIG. 8, the prototype model is further customized in a variety of ways based on predetermined configuration attributes. In one embodiment, the predetermined configuration attributes are created in the BIM platform and are automatically implemented by the modeling system 300 to change the prototype model accordingly. The configuration component 360 presents the user with customizable attributes or options 802 available for the prototype model. In one embodiment, the attributes are client specific. In another embodiment, the attributes are building specific. The configuration component 360 can customize the prototype model according to specific building requirements. For example, the inclusion and location of a path, an entryway, a drive through, and the like. In one embodiment, the configuration component 360 generates and displays a preview 804 of the building such that the user can visually appreciate the changes before confirming the selections to be included in an AOR model, e.g., final model incorporating customizations.

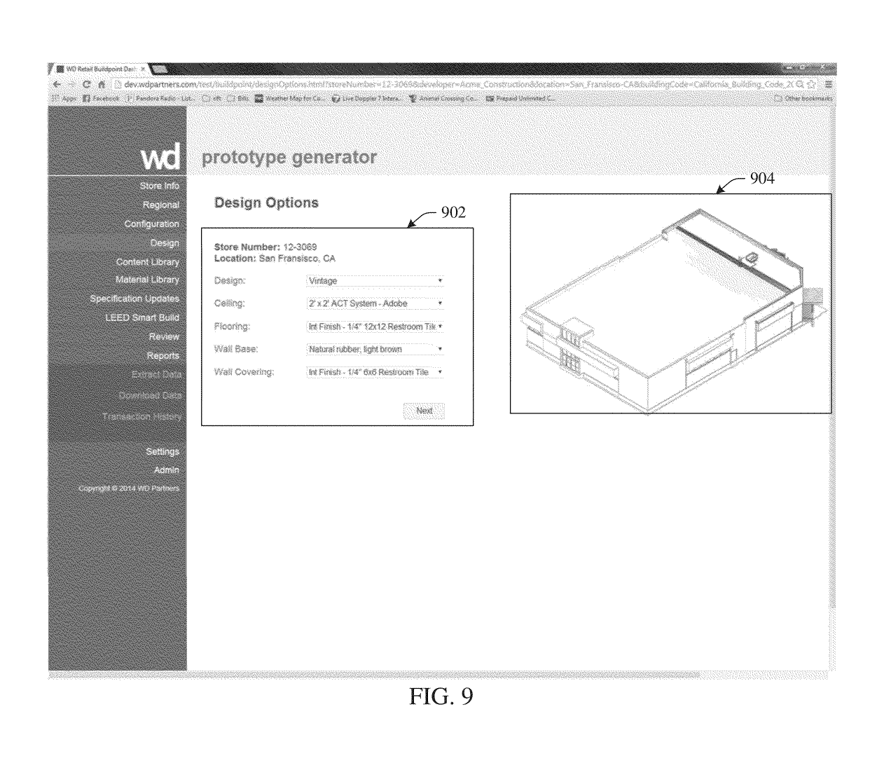

The modeling system 300 includes a design component 370. The design component 370 provides additional design customization attributes or options. With reference to FIG. 9, the prototype model is further customized in a variety of ways based on predetermined (or user-defined) configuration attributes. In one embodiment, the predetermined configuration attributes are created in the BIM software and are automatically implemented on an elemental level by the modeling system 300 to modify the prototype model accordingly. The design component 370 presents the user with design customizable attributes or options 902 available for the prototype model. The design customization attributes 902 can include a selection among one or more design themes. The design themes can be architectural styles that include specific materials and/or stylistic features. For example, the design themes can be vintage, modern, and the like. The design component 370 can also present selections for specific design type elements and/or materials to be used in the building and included in the AOR model. For example, the selections can include ceiling type, height and/or material, flooring type and/or material, wall base type and/or material, wall covering type and/or material, etc. In one embodiment, the design component 370 generates and displays a preview 904 of the building such that the user can visually appreciate the changes before confirming the selections to be included in an AOR model, e.g., final model having customizations.

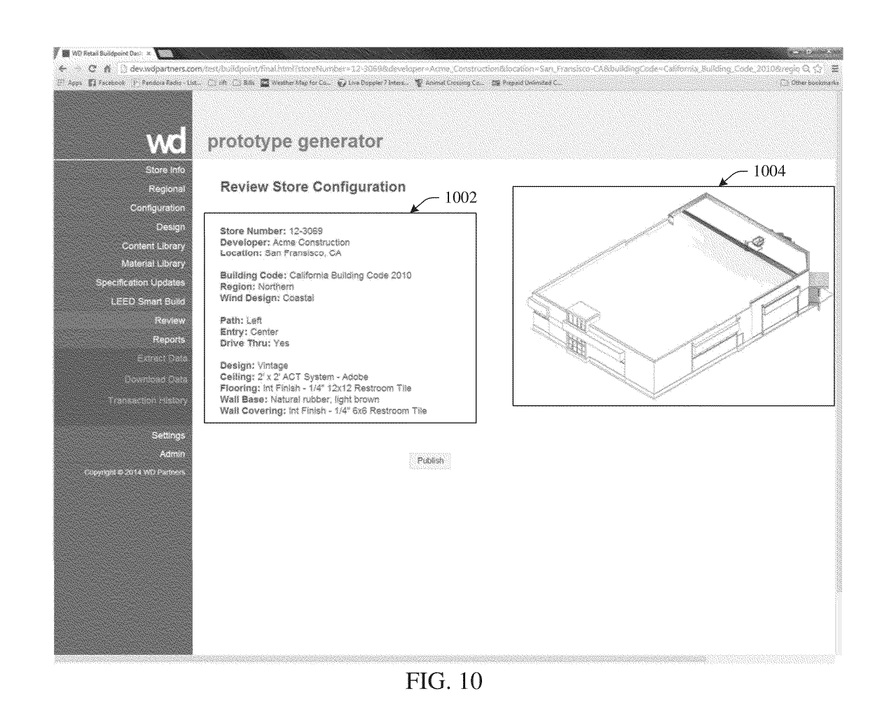

The modeling system 300 further includes a reporting component 380. The reporting component can use the AOR models through their life cycle and report on any or all aspects of a client's business model. A wide variety of information can be tracked and reported in various aspects, which can depend upon specific features built into the model and families In one embodiment, the user can log into the dashboard and view pre-built reporting nodes. These nodes can include nodes custom-built according to the user needs, as well as default nodes. With reference to FIG. 10, the reporting component 380 can provide an overview of the model options 1002 selected and/or confirmed from the previous components, e.g., modeling stages. In one embodiment, the reporting component 380 generates and displays a final model 1004 of the building that incorporates the user customizations such that the user can visually appreciate an AOR model, e.g., final model incorporating customizations.

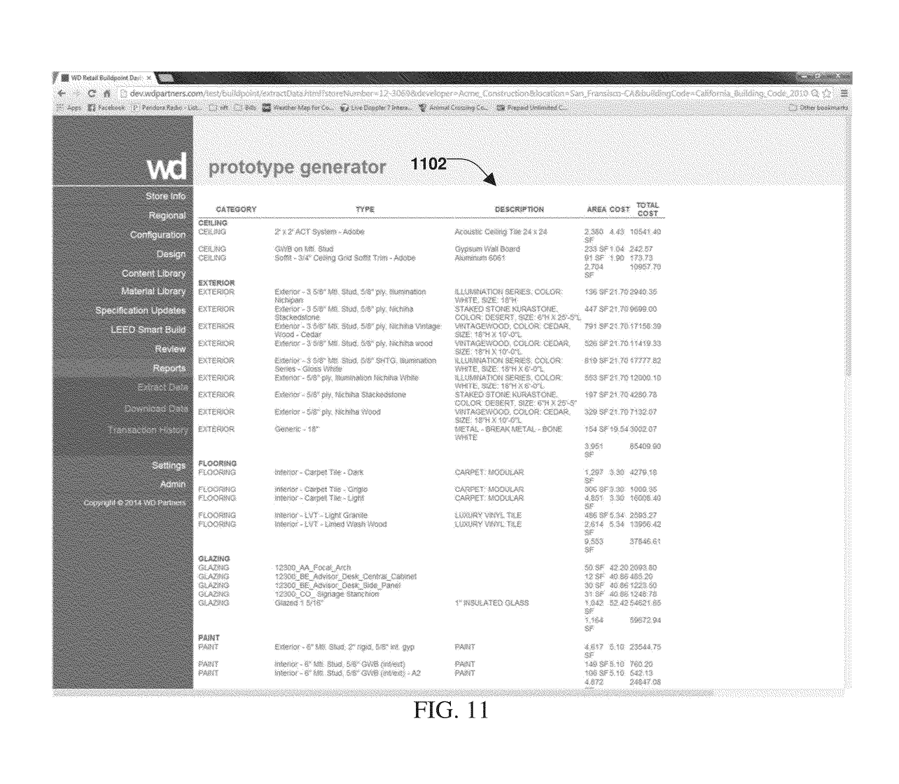

With reference to FIG. 11, the reporting component 380 can provide a detailed report 1102. The detailed report 1102 includes a listing of a complete build of materials for constructing the building from the AOR model. The detailed report 1102 includes categories of materials, along with types of materials used by a client in each category, associated descriptions, total quantities of the material used, unit costs, total costs, and the like. The reports facilitate monitoring of objects and materials used in connection with various buildings, allowing for replacement and restocking of materials, as well as the ability to predict which materials and objects may be used in the future based on past data. Additionally, the reports can be used to obtain valuable information regarding industry trends, such as regarding buildings built, e.g., specified by region, by time frames, etc., materials used, and the like.

In one embodiment, when the prototype model is finalized as an AOR model it can be stored by the storage component 340 for future use as a prototype model.

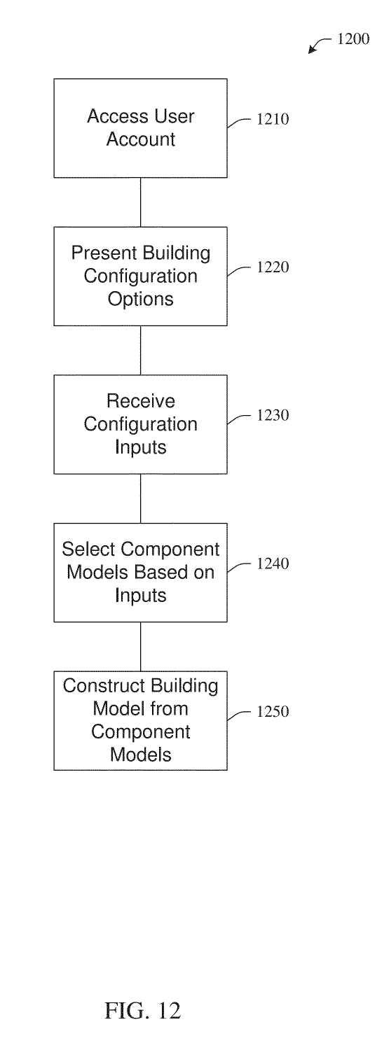

With reference to FIG. 12, an example method 1200 is depicted for generation of a model for a building in accordance with aspects of the subject innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

In aspects, method 1200 can begin at 1210 by accessing a user account, such as in response to a user (e.g., AOR, etc.) login. The user account can include associated information such as model prototypes, families, component models useable to assemble a complete building model based configuration selections, etc., and can be associated with one or more entities (e.g., a company that uses similar building designs at various stores, etc.). At 1220, building configuration options can be presented to a user to select among, such as those discussed herein. Various configuration options selected by the user can be received at 1230, and at 1240, appropriate component models (e.g., including appropriate building materials, etc. corresponding to the building code, appropriate building design for wind considerations, etc.) corresponding to the received configuration inputs can be selected. At 1250, a building model can be constructed or compiled as a kit of parts from the component models selected based on the received user inputs. It is to be understood that criteria and configurations discussed herein are for the purposes of example only, and individual users can specify, import, or design individualized configurations, component models, etc. within the scope of this specification.

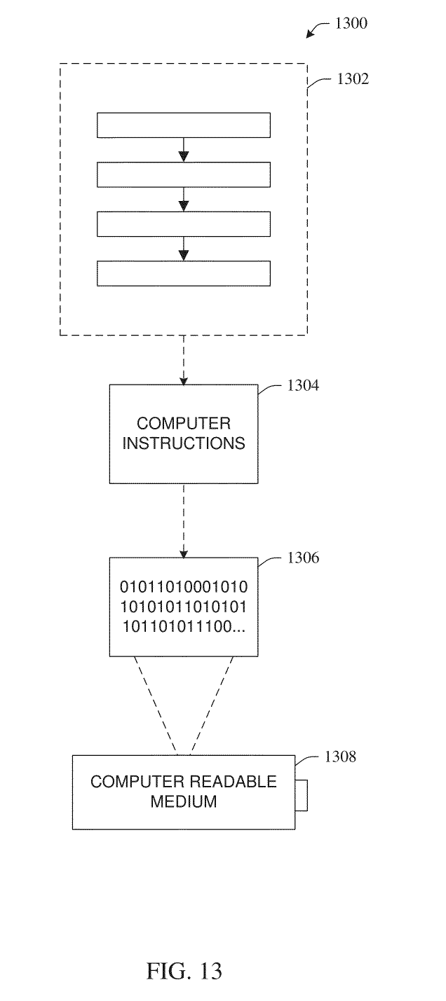

Still another embodiment can involve a computer-readable medium comprising processor-executable instructions configured to implement one or more embodiments of the techniques presented herein. An embodiment of a computer-readable medium or a computer-readable device that is devised in these ways is illustrated in FIG. 13, wherein an implementation 1300 comprises a computer-readable medium 1308, such as a CD-R, DVD-R, flash drive, a platter of a hard disk drive, etc., on which is encoded computer-readable data 1306. This computer-readable data 1306, such as binary data comprising a plurality of zero's and one's as shown in 1306, in turn comprises a set of computer instructions 1304 configured to operate according to one or more of the principles set forth herein. In one such embodiment 1300, the processor-executable computer instructions 1304 is configured to perform a method 1302, such as at least a portion of one or more of the methods described in connection with embodiments disclosed herein. In another embodiment, the processor-executable instructions 1304 are configured to implement a system, such as at least a portion of one or more of the systems described in connection with embodiments disclosed herein. Many such computer-readable media can be devised by those of ordinary skill in the art that are configured to operate in accordance with the techniques presented herein.

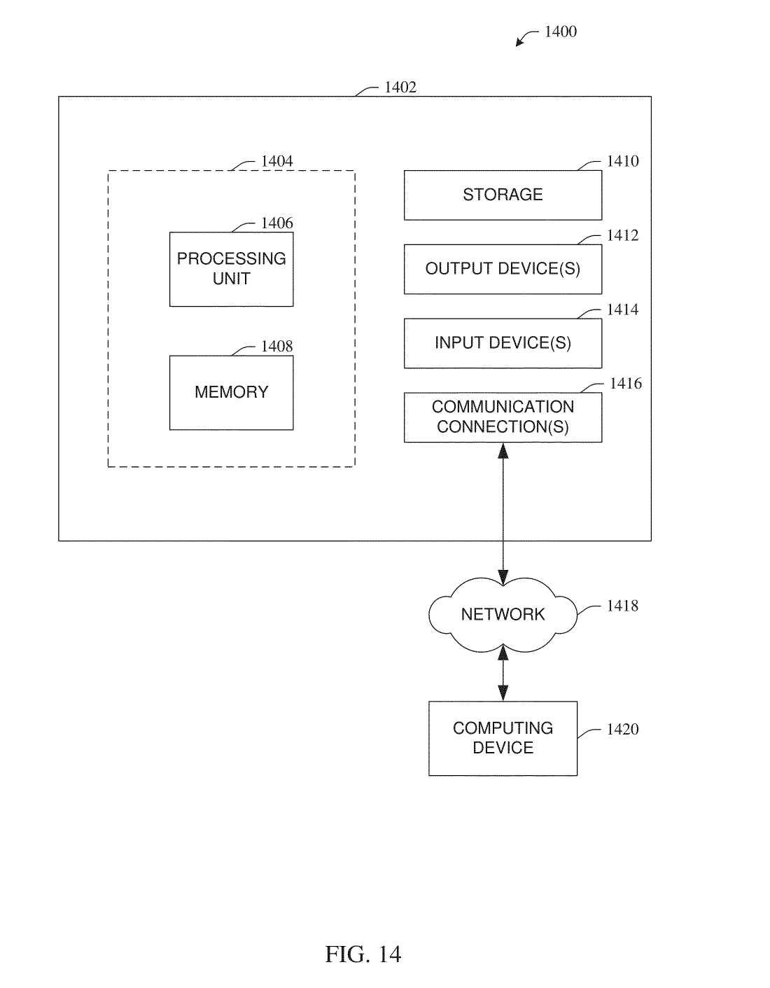

FIG. 14 and the following discussion provide a description of a suitable computing environment in which embodiments of one or more of the provisions set forth herein can be implemented. The operating environment of FIG. 14 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 14 illustrates a system 1400 comprising a computing device 1402 configured to implement one or more embodiments provided herein. In one configuration, computing device 1402 can include at least one processing unit 1406 and memory 1408. Depending on the exact configuration and type of computing device, memory 1408 may be volatile, such as RAM, non-volatile, such as ROM, flash memory, etc., or some combination of the two. This configuration is illustrated in FIG. 14 by dashed line 1404.

In these or other embodiments, device 1402 can include additional features or functionality. For example, device 1402 can also include additional storage such as removable storage or non-removable storage, including, but not limited to, magnetic storage, optical storage, and the like. Such additional storage is illustrated in FIG. 14 by storage 1410. In some embodiments, computer readable instructions to implement one or more embodiments provided herein are in storage 1410. Storage 1410 can also store other computer readable instructions to implement an operating system, an application program, and the like. Computer readable instructions can be accessed in memory 1408 for execution by processing unit 1406, for example.

The term “computer readable media” as used herein includes computer storage media. Computer storage media includes volatile and nonvolatile, removable and non-removable media implemented in any method or technology for storage of information such as computer readable instructions or other data. Memory 1408 and storage 1410 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1402. Any such computer storage media can be part of device 1402.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 1402 can include one or more input devices 1414 such as keyboard, mouse, pen, voice input device, touch input device, infrared cameras, video input devices, or any other input device. One or more output devices 1412 such as one or more displays, speakers, printers, or any other output device can also be included in device 1402. The one or more input devices 1414 and/or one or more output devices 1412 can be connected to device 1402 via a wired connection, wireless connection, or any combination thereof. In some embodiments, one or more input devices or output devices from another computing device can be used as input device(s) 1414 or output device(s) 1412 for computing device 1402. Device 1402 can also include one or more communication connections 1416 that can facilitate communications with one or more other devices 1420 by means of a communications network 1418, which can be wired, wireless, or any combination thereof, and can include ad hoc networks, intranets, the Internet, or substantially any other communications network that can allow device 1402 to communicate with at least one other computing device 1420.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates architectural design, comprising:
a prototype component that accesses a model of a building, the model comprising a plurality of sets of attributes defining the model; and
a storage component that stores the sets of attributes, wherein the system accesses and modifies a subset of the plurality of sets of attributes stored on the storage component, the plurality of sets of attributes are component models that automate a plurality of elemental modifications to the model.

2. The system of claim 1, wherein the plurality of sets of attributes are generalized options corresponding to elemental modifications of the model, wherein a user can select a generalized option, and the model is modified with the elemental modifications according to the selected generalized option.

3. The system of claim 1, further comprising:
a regional component that modifies a geographical set of attributes of the storage component.

4. The system of claim 3, wherein the geographical set of attributes includes at least one of a model location, building codes, building regulations, or a wind design.

5. The system of claim 1, further comprising:
a configuration component that customizes a structural set of attributes of the storage component.

6. The system of claim 5, wherein the structural set of attributes is defined by a plurality client options detailing the structure of the building.

7. The system of claim 5, wherein the structural set of attributes includes at least one of a path, entryway, or drive through.

8. The system of claim 1, further comprising:
a design component that customizes a style set of attributes of the storage component.

9. The system of claim 8, wherein the style set of attributes can include a design theme, the design theme corresponding to an architectural style which customizes the model with stylistic features or specific building materials.

10. The system of claim 8, wherein the style set of attributes are stylistic building materials including at least one of a ceiling, wall base, or wall covering.

11. The system of claim 1, further comprising:
a reporting component for generating a report to be presented to a user.

12. A method of facilitating architectural design, comprising:
accessing a model having an initial plurality of sets of attributes defining the model; and
customizing the model by modifying at least one attribute of the plurality of sets of attributes, wherein the sets of attributes are component models to automate modifications to the model.

13. The method of claim 12, further comprising:
accessing a geographical set of attributes according to a model location, wherein the geographical set of attributes comprises location specific attributes as determined by the model location.

14. The method of claim 12, further comprising:
accessing and modifying a structural set of attributes, wherein the structural set of attributes comprises a plurality of client options detailing the structure of the building.

15. The method of claim 12, further comprising:
accessing and modifying a design set of attributes, wherein the design set of attributes comprises a plurality of design themes corresponding to different architectural styles.

16. The method of claim 15, wherein the design set of attributes include stylistic building materials options including at least one of a ceiling type, wall base, or wall covering.

17. The method of claim 12, further comprising:
reviewing modifications made to the model; and
confirming attributes of the model that are not modified.

18. The method of claim 12, further comprising:
generating a report detailing the elemental components that comprise the building, the elemental components reflecting modified and non-modified components to building the building according to the model.

19. A method of facilitating architectural design, comprising:
accessing a user account, wherein the user account is associated with one or more families of objects and a plurality of component models;
receiving a set of selected configuration options;
selecting one or more component models, wherein each of the selected one or more component models is associated with a configuration option of the set of selected configuration options; and
constructing a building model from the selected component models.

20. The method of claim 19, wherein the component models relate to at least one of location, structure, or design.
